(19) United States
(12) Patent Application Publication
(10) Pub. No.: US 2008/0080685 A1
(43) Pub. Date: Apr. 3, 2008

(54) Systems and Methods for Recording in a Contact Center Environment

(75) Inventors: Robert John Barnes, Watford Herts (GB); Jamie Richard Williams, Fleet (GB); Marc Calahan, Woodstock, GA (US); Thomas Z. Dong, Marietta, GA (US)

Correspondence Address: M. Paul Qualey, Jr.;THOMAS, KAYDEN, HORSTEMEYER & RISLEY, L.L.P., Suite 1750, 100 Galleria Parkway, N.W., Atlanta, GA, 30039-5948, US

(73) Assignee: WITNESS SYSTEMS, INC., Roswell, GA (US)

(21) Appl. No.: 11/692,983

(22) Filed: Mar. 29, 2007

Related U.S. Application Data
(63) Continuation-in-part of application No. 11/529,947, filed on Sep. 29, 2006.

(51) Int. Cl. H04M 15/00

(52) U.S. Cl. 379/112.05

(57) ABSTRACT

Systems and methods for recording in a customer center environment are provided. In this regard, a representative method comprises: receiving data related to a communication; communicating with a recording system to determine the processing capabilities of the recording system; determining whether to adjust packet size of the data based on the processing capabilities of the recording system; responsive to determining that the packet size is to be adjusted, adjusting the packet size of the data based on the processing capabilities of the recording system; and transmitting the data with the adjusted packet size to the recording system.

### CROSS REFERENCE TO RELATED APPLICATION

This application is a continuation-in-part of copending U.S. utility application entitled, “Systems and Methods for Endpoint Recording Using Gateways,” having Ser. No. 11/529,947, filed on Sep. 29, 2006, which is hereby incorporated by reference in its entirety.

### TECHNICAL FIELD

The present disclosure is generally related to recording communications and, more particularly, is related to systems and methods for recording the communications in a customer center.

### BACKGROUND

A traditional passive tap recording technique includes recorders that are deployed along routes of communications. In this technique, each recorder operates similar to a “sniffer” by analyzing pass-by communication packets. The recorder records the packets corresponding to certain communication sessions based on its configuration. In an IP telephony environment, recorders are typically deployed either at the voice gateway, which interfaces between Internet Protocol (IP) network and public switched telephone network (PSTN), or at switches in order to stay along the routes of the communications. This technique has the advantages of (1) minimum intrusion to a communication system, (2) cost effectiveness in deployment for companies with centralized office locations, and (3) easy scalability for compliance recording. However, for companies with many distributed branch offices, the above advantages start to diminish. This is especially true if the purpose of the recorders is for quality monitoring.

With the growing usage of Voice over Internet Protocol (VoIP) technology, many telephony-based businesses, such as customer centers, are adopting distributed telephony systems with local access to PSTN, which are still controlled by centralized soft switches. Many customer centers are using at-home agents with soft-phones on their personal computers (PCs). Hence, some of the communications in the distributed telephony system may not be “along the communication route” that is needed for passive tap recording. Secondly, network security has now become a concern. The deployment of encryption technology has made passive tap recording become even more problematic.

In addition, many customer centers deploy recorders for quality monitoring purposes, instead of compliance. In this regard, only a small percentage of the communications are recorded, monitored, and sampled. However, to assure the accuracy of the sampling, communications are randomly selected for recording across all branch offices. With passive tap recording, a large number of recorders are potentially required and each recorder may have low usage.

Described below is a typical IP-based customer center using the passive tapping “sniffing” recording method. To communicate with any agents at the customer center, a customer communication device, such as a time domain multiplexing (TDM) or an IP phone, first sends communication signals to a call-processing device of the customer center, such as a soft switch. The communication signals can be sent either directly to the call-processing device in case of IP to IP communications or via a media processing device, such as a voice gateway in case of TDM to IP. The communication network can be a PSTN network or IP-based network. Once the communication signals have been received, the call-processing device then routes the communication signals to an agent phone.

After several rounds of communication signals exchange, media communications between the agent's phone and customer's phone can proceed via media processing device and distribution devices. The distribution devices are network routers and switches. In order to record the media communications using passive tapping, recorders are deployed at the media processing device or distribution devices using the network traffic monitoring or duplicating features, such as the Cisco's Switch Port Analyzer (SPAN) feature, on these devices. These tapping features are often available to the recorders that are directly connected to the media processing device or distribution devices, namely to recorders deployed at each branch office. Hence, a large customer center having multiple branches, such as a branch in New York, a branch in Los Angeles, and a branch in Chicago, may need multiple recorders in each branch to record the voice communications.

Data associated with communications are being increasingly recorded in customer centers to be monitored for quality, performance, among others. Recorders receive and process the communications data before recording the communications data. The characteristics of the received communications data may reduce the performance of the recorders by causing excess processing of the communications data.

### SUMMARY

Systems and methods for recording in a customer center environment are provided. In this regard, a representative method comprises: receiving data related to a communication; communicating with a recording system to determine the capabilities of the recording system; determining whether to adjust the packet size of the data based on the processing capabilities of the recording system; responsive to determining that the packet size is to be adjusted, adjusting the packet size of the data based on the processing capabilities of the recording system; and transmitting the data with the adjusted packet size to the recording system.

Briefly described, in architecture, one embodiment of the system, among others, can be implemented as follows. In this regard, a representative system comprises: a recording system that records communications data associated with an incoming call via a network; and a telephony component that is operable to communicate with a recording system to determine the processing capabilities of the recording system. The telephony component is further operable to determine whether to adjust packet size of the data based on the processing capabilities of the recording system. Responsive to determining that the packet size is to be adjusted, the telephony component is further operable to receive the communications data and adjust the packet size of the data based on the processing capabilities of the recording system. The telephony component is further operable to transmit the communications data with the adjusted packet size to the recording system.

Briefly described, in architecture, one embodiment of the system, among others, can be implemented as follows. In this regard, a representative media processing and distributing device comprises: logic for receiving data related to a communication; logic for communicating with a recording system to determine the processing capabilities of the recording system; logic for determining whether to adjust packet size of the data based on the processing capabilities of the recording system; logic for responsive to determining that the packet size are to be adjusted, adjusting the packet size of the data based on the processing capabilities of the recording system; and logic for transmitting the data with the adjusted packet size to the recording system.

Other systems, methods, features, and advantages of this disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

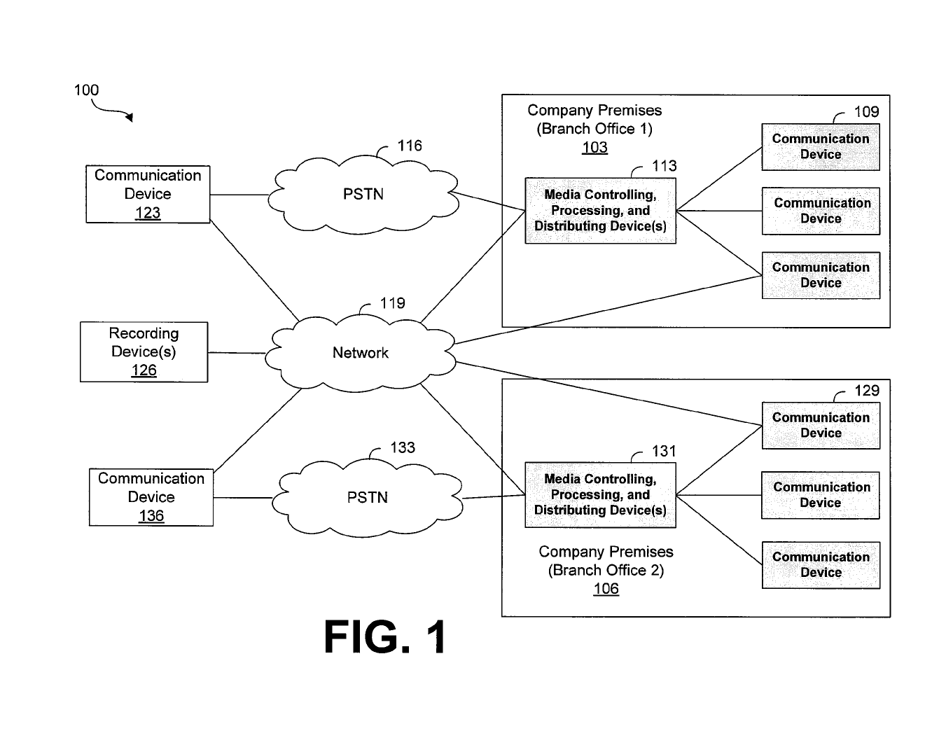

FIG. 1 is a schematic diagram of an embodiment of a system in which communication can be recorded by a recorder located on an associated network;

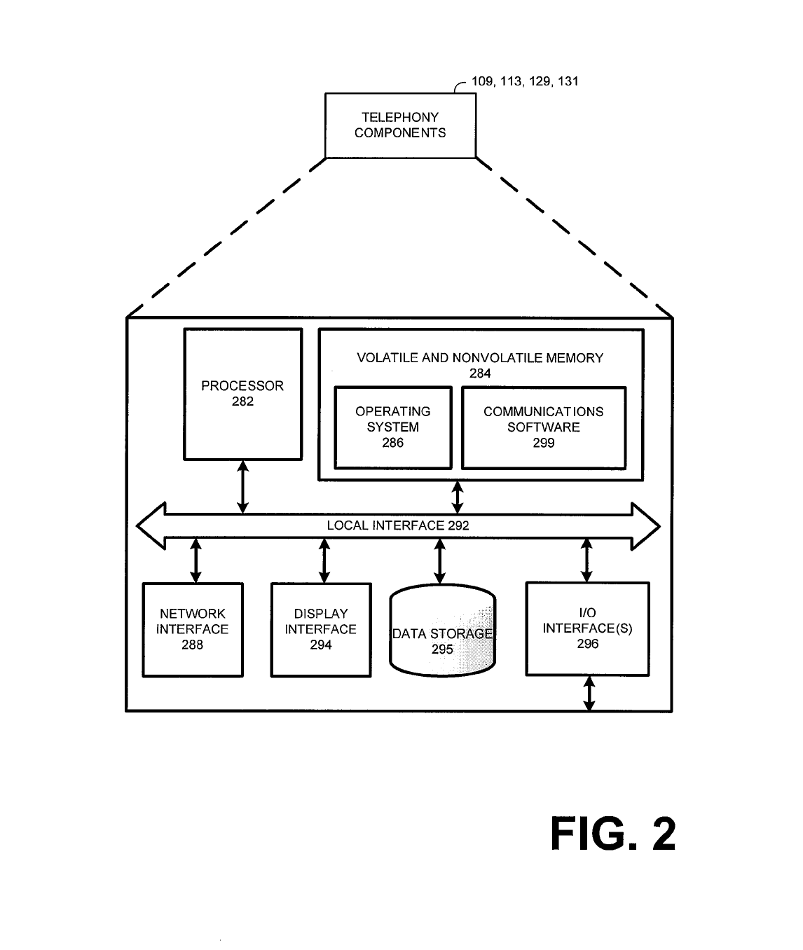

FIG. 2 is an exemplary diagram illustrating an embodiment of a telephony component that can be configured to facilitate recording of a communication in a communications network, such as that shown in FIG. 1;

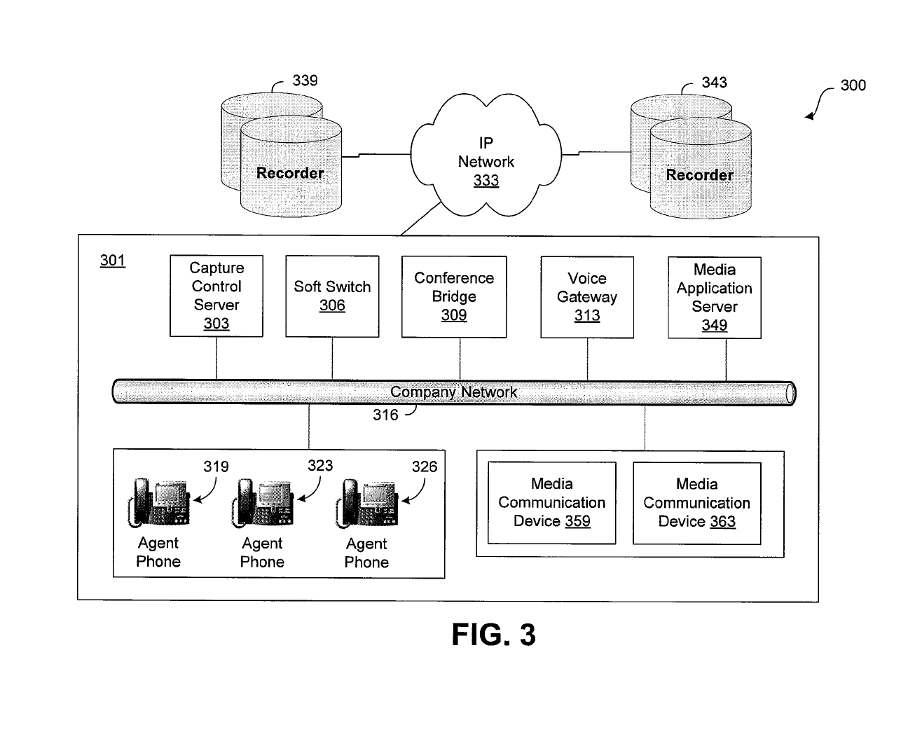

FIG. 3 is a schematic diagram of an embodiment of a system in which a communication can be recorded by a recorder in a customer center using a soft switch, conference bridge, agent phone, media communication device, voice gateway, capture control server, and/or media application server;

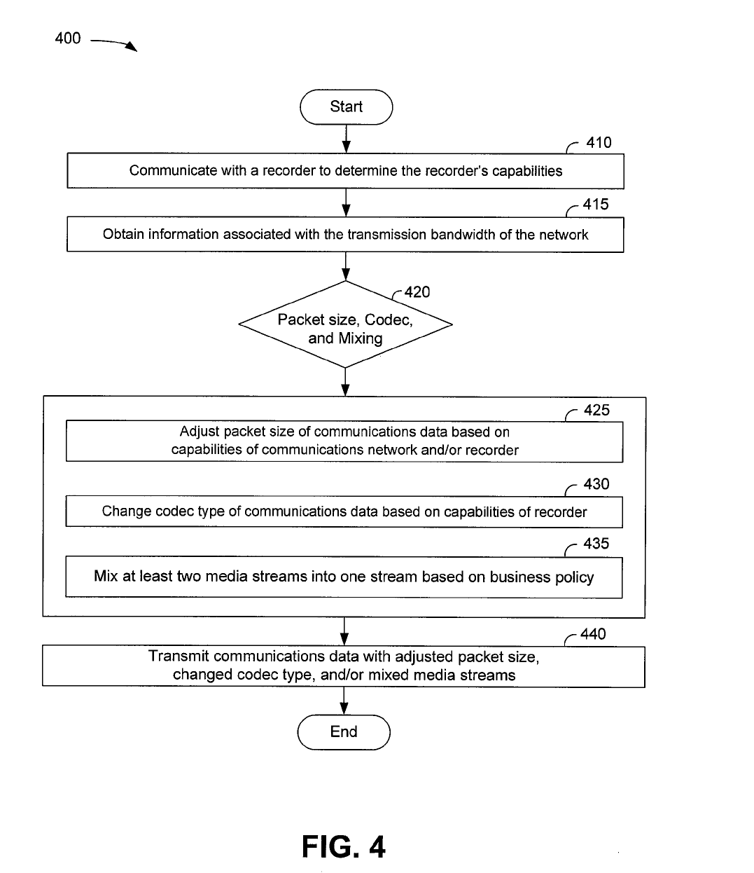

FIG. 4 is a flowchart illustrating exemplary steps that can be taken by a telephony component for recording a contact in a communications network, such as that described in FIG. 3;

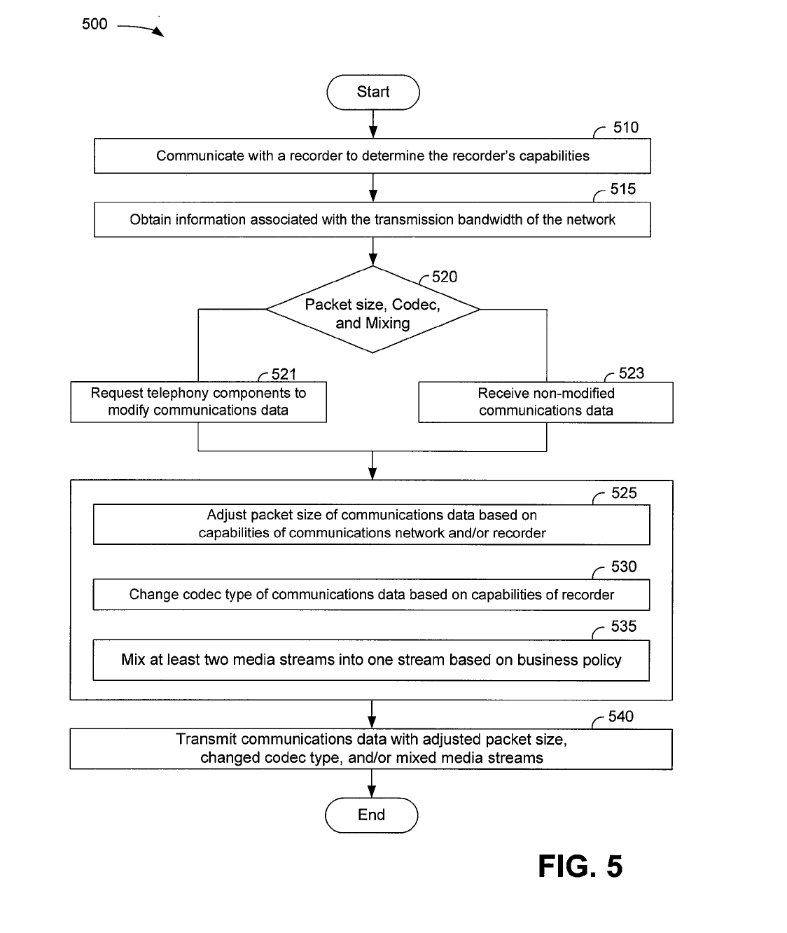

FIG. 5 is a flowchart illustrating exemplary steps that can be taken during conferencing, duplicate media streaming, and storing-forwarding for recording communication in a communications network, such as that described in FIG. 3; and

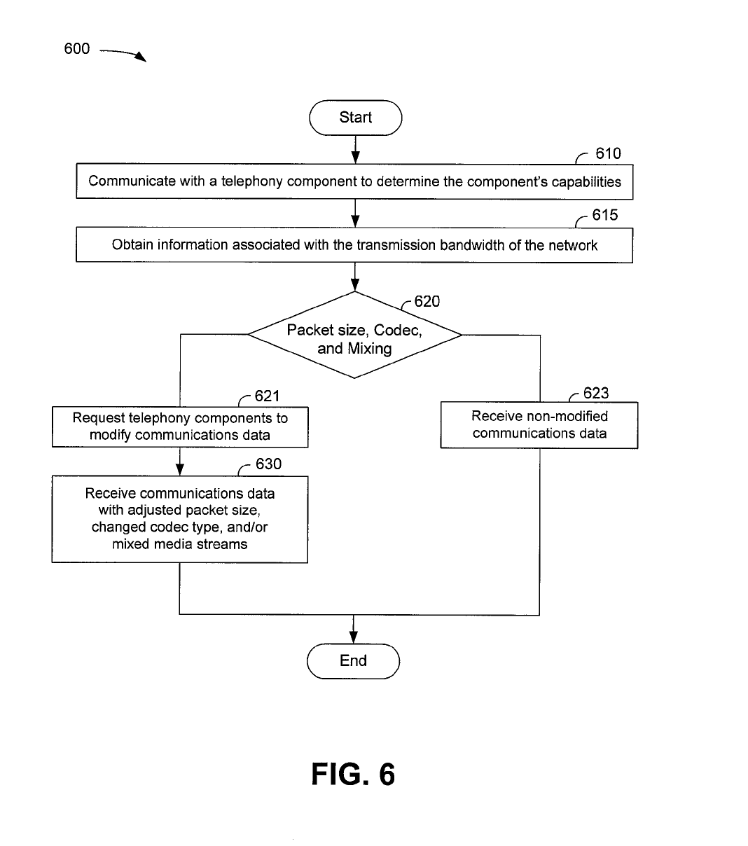

FIG. 6 is a flowchart illustrating exemplary steps that can be taken for a recorder in a communications network, such as that described in FIG. 3.

### DETAILED DESCRIPTION

Included in this disclosure are embodiments of integrated workforce optimization platforms, as discussed in U.S. application Ser. No. 11/359,356, filed on Feb. 22, 2006, entitled “Systems and Methods for Workforce Optimization,” which is hereby incorporated by reference in its entirety. At least one embodiment of an integrated workforce optimization platform integrates: (1) Quality Monitoring/Call Recording—voice of the customer; the complete customer experience across multimedia touch points; (2) Workforce Management—strategic forecasting and scheduling that drives efficiency and adherence, aids in planning, and helps facilitate optimum staffing and service levels; (3) Performance Management—key performance indicators (KPIs) and scorecards that analyze and help identify synergies, opportunities and improvement areas; (4) e-Learning—training, new information and protocol disseminated to staff, leveraging best practice customer interactions and delivering learning to support development; and/or (5) Analytics—deliver insights from customer interactions to drive business performance. By way of example, the integrated workforce optimization process and system can include planning and establishing goals—from both an enterprise and center perspective—to ensure alignment and objectives that complement and support one another. Such planning may be complemented with forecasting and scheduling of the workforce to ensure optimum service levels. Recording and measuring performance may also be utilized, leveraging quality monitoring/call recording to assess service quality and the customer experience.

Exemplary systems are first discussed with reference to the figures. Although these systems are described in detail, they are provided for purposes of illustration only and various modifications are feasible. After the exemplary systems are described, examples of flow diagrams and sequence diagrams of the systems are provided to explain the manner in which communications data can be recorded.

Referring now in more detail to the figures, FIG. 1 is a schematic diagram of an embodiment of a system in which communication at a company, e.g., a customer center, can be recorded by a recorder located on a network 119, such as an Internet Protocol (IP) Network, connected to the company. As used herein, a customer center includes, but is not limited to, outsourced contact centers, outsourced customer relationship management, customer relationship management, voice of the customer, customer interaction, contact center, multi-media contact center, remote office, distributed enterprise, work-at-home agents, remote agents, branch office, back office, performance optimization, workforce optimization, hosted contact centers, and speech analytics, for example.

The embodiments of systems and methods of recording media communication via a recorder are discussed in U.S. application Ser. No. 11/394,496, filed on Mar. 31, 2006, entitled “Duplicate Media Stream,” which is hereby incorporated by reference in its entirety, U.S. application Ser. No. 11/394,410, filed on Mar. 31, 2006, entitled “Systems and Methods for endpoint recording using phones,” which is hereby incorporated by reference in its entirety, U.S. application Ser. No. 11/395,350, filed on Mar. 31, 2006, entitled “Systems and Methods for endpoint recording using a conference bridge,” which is hereby incorporated by reference in its entirety, U.S. application Ser. No. 11/395,759, filed on Mar. 31, 2006, entitled “Systems and Methods for endpoint recording using a media application server,” which is hereby incorporated by reference in its entirety, U.S. application Ser. No. 11/529,947, filed on Sep. 29, 2006, entitled “Systems and Methods for endpoint recording using gateways,” which is hereby incorporated by reference in its entirety, and U.S. application Ser. No. 11/540,902, filed on Sep. 29, 2006, entitled “Systems and Methods for endpoint recording using recorders,” which is hereby incorporated by reference in its entirety.

Referring back to FIG. 1, two branch offices 103, 106 are depicted that may need to record communication between employees and between employees and customers. Customer communication devices 123, 136 connect to branch offices 103, 106 either via the network 119 or via a Public Switched Telephony Network (PSTN) 116, 133, or both, respectively. The customer communication devices 123, 136 can include, but are not limited to, telephones, soft-phones on hand held devices, or Personal Computers.

Recording device(s) 126 can be deployed on the network 119 connected to the branch offices 103, 106. Alternatively or additionally, the recording devices 126 can communicate with media controlling/processing/distributing devices 113, 131 in a secure encrypted environment, for getting communication events and for sending instructions. For example, the recording devices 126 can communicate with telephony components at the company premises 103, 106 to distribute recording-related transcoding for desired recording performances or based on a business policy. One advantage, among others, is that the recording devices 126 can reduce their processing load by having a telephony component, such as a handset, store-forward device, soft switch, gateway, conference bridge, and/or media application server, to adjust the packet size and/or change the codec of a communication data before the recording devices 126 receive the communication data. The modified communication data can increase the performance of the recording devices 126 by reducing the processing load of the recording devices 126.

Embodiments of a store-forward device are discussed in U.S. Application Ser. No. 11/394,408, filed on Mar. 31, 2006, entitled “Distributed Voice Over Internet Protocol Recording,” which is hereby incorporated by reference in its entirety. In operation, embodiments of the store-forward device can include, but not limited to, communication devices 109, 129 and media controlling/processing/distributing devices 113, 131. Screen capture of various data related to a communication can be implemented such that an application server can contact the capture daemon and obtain screen frames associated with a communication. Similarly, for voice capture, many communications devices, such as IP telephones, generally include a small switching hub and can be wired in between a local network infrastructure and the media controlling/processing/distributing devices 113, 131 proximate to the communications devices 109, 129.

With the capability of the recording devices 126 to communicate with the media controlling/processing/distributing devices 113, 131, the recording device 126 can request to modify data associated with communications at the customer center before receiving and recording the communications data. Alternatively or additionally, if a recording device is a cluster of recording devices, the recording device can communicate with the media controlling/processing/distributing devices 113, 131 to select which recording device from the cluster of recording devices to record the communications for load balancing purposes.

The media controlling/processing devices control the communication between customers and employees and between employees. The media controlling/processing devices can include, but are not limited to, voice gateways, soft switches, conference bridges, and multi-media application servers. The distributing devices can include, but are not limited to, routers and switches. Based on static configuration or instructions from the recording devices, the media controlling/processing devices can duplicate and transmit on-going communication between communication devices 109, 129, 123, 136 to the recording devices via the network 119 using its media processing features. Alternatively or additionally, the media controlling/processing devices can also instruct a communication device 109, 129 at the company premises 103, 106, respectively, to duplicate and transmit any on-going communications to the recording devices 126 using media processing features on the communication devices 109, 129.

FIG. 2 is an exemplary diagram illustrating an embodiment of a telephony component 109, 113, 126, 129, 131 that can be configured to facilitate recording communication in a communications network, such as that shown in FIG. 1. Although a wire-line device is illustrated, this discussion can be applied to any device. Generally, in terms of hardware architecture, as shown in FIG. 2, each component 109, 113, 126, 129, 131 can include a processor 282, volatile and nonvolatile memory 284, a display interface 294, data storage 295, and one or more input and/or output (I/O) device interface(s) 296 that are communicatively coupled via a local interface 292. The local interface 292 can include, for example, but not limited to, one or more buses or other wired or wireless connections. The local interface 292 may have additional elements, which are omitted for simplicity, such as controllers, buffers (caches), drivers, repeaters, and receivers to enable communications. Further, the local interface may include address, control, and/or data connections to enable appropriate communications among the aforementioned components.

The processor 282 can be a hardware device for executing software, particularly software stored in the volatile and nonvolatile memory 284. The processor 282 can be any custom made or commercially available processor, a central processing unit (CPU), an auxiliary processor among several processors associated with the telephony component 109, 113, 126, 129, 131, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard® Company, an 80×86 or Pentium® series microprocessor from Intel® Corporation, a PowerPC® microprocessor from IBM®, a Sparc® microprocessor from Sun Microsystems®, Inc, or a 68xxx series microprocessor from Motorola® Corporation.

The volatile and nonvolatile memory 284 can include any one or combination of volatile memory elements (e.g., random access memory (RAM), such as DRAM, SRAM, SDRAM, etc.) and nonvolatile memory elements (e.g., read-only memory (ROM), hard drive, tape, CDROM, etc.). Moreover, the memory 284 can incorporate electronic, magnetic, optical, and/or other types of storage media. Note that the volatile and nonvolatile memory 284 can have a distributed architecture, where various components are situated remote from one another, but can be accessed by the processor 282.

The software in the volatile and nonvolatile memory 284 may include one or more separate programs, each of which includes an ordered listing of executable instructions for implementing logical functions. In the example of FIG. 2, the software in the volatile and nonvolatile memory 284 may include a communications software 299, as well as an operating system 286. The communications software 299 can include logic configured to adjust packet size, change codec type, and mix communications data for transmission over a data network, as well as logic configured to otherwise facilitate a communication. As a nonlimiting example, embodiments of communications software 299 are configured to increase or decrease the packet size, change codec type, and mix the communications data to improve performance of the recorders and network.

Similarly, with respect to operating system 286, a nonexhaustive list of examples of suitable commercially available operating systems is as follows: (a) a Windows® operating system available from Microsoft® Corporation; (b) a Netware® operating system available from Novell®, Inc.; (c) a Macintosh® operating system available from Apple® Computer, Inc.; (d) a UNIX operating system, which is available for purchase from many vendors, such as the Hewlett-Packard® Company, Sun Microsystems®, Inc., and AT&T® Corporation; (e) a LINUX® operating system, which is a freeware that is readily available on the Internet; (f) a run time Vxworks® operating system from WindRiver® Systems, Inc.; or (g) an appliance-based operating system, such as that implemented in handheld computers or personal data assistants (PDAs) (e.g., PalmOS® available from Palm® Computing, Inc., and Windows CE® available from Microsoft® Corporation). The operating system 286 can be configured to control the execution of other computer programs and provides scheduling, input-output control, file and data management, memory management, and communication control and related services.

A system component embodied as software may also be construed as a source program, executable program (object code), script, or any other entity comprising a set of instructions to be performed. When constructed as a source program, the program is translated via a compiler, assembler, interpreter, or the like, which may or may not be included within the volatile and nonvolatile memory 284, so as to operate properly in connection with the Operating System 286.

The Input/Output devices (not shown) that can be coupled to the I/O Interface(s) 296 can include input devices, for example, but not limited to, a keyboard, mouse, scanner, microphone, headset, handset, microphone, earphone, etc. Further, the Input/Output devices can also include output devices, for example, but not limited to, a printer, display, etc. Finally, the Input/Output devices can further include devices that communicate both as inputs and outputs, for example, but not limited to, a modulator/demodulator (modem; for accessing another device, system, or network), a radio frequency (RF) or other transceiver, a telephonic interface, a bridge, a router, etc.

If the telephony component 109, 113, 126, 129, 131 is a personal computer, workstation, or the like, the software in the volatile and nonvolatile memory 284 can further include a basic input output system (BIOS) (omitted for simplicity). The BIOS is a set of software routines that initialize and test hardware at startup, start the Operating System, and support the transfer of data among the hardware devices. The BIOS is stored in ROM so that the BIOS can be executed when the telephony component 109, 113, 126, 129, 131 is activated.

When the telephony component 109, 113, 126, 129, 131 is in operation, the processor 282 is configured to execute software stored within the volatile and nonvolatile memory 284, to communicate data to and from the volatile and nonvolatile memory 284, and to generally control operations at the communications device 106 pursuant to the software. Software in memory, in whole or in part, are read by the processor 282, perhaps buffered within the processor 282, and then executed.

FIG. 3 is a schematic diagram of an embodiment of a system 300 in which communication can be recorded by a recorder 339, 343 in a customer center using a capture control server 303, soft switch 306, conference bridge 309, agent phones 319, 323, 326, media communication devices 359, 363, voice gateway 313, and media application server 349, respectively, via an IP network 333 or any communications network. The capture control server 303, soft switch 306, conference bridge 309, agent phones 319, 323, 326, media communication devices 359, 363, voice gateway 313, and media application server 349 communicate with each other in a telephony system 301 via a company network 316. The company network 316 and IP network 333 can include, but are not limited to, a wide area network (WAN), a local area network (LAN), a virtual private network (VPN) and the Internet.

### Spanning

In order to record the data associated with communications at the customer center using passive tapping, recorders are deployed at the media processing device or distribution devices using a SPAN feature on these devices. These tapping features are often available to the recorders that are directly connected to the media processing device or distribution devices, namely to recorders deployed at each branch office. The devices using the SPAN features can include, but are not limited to switch 306, voice gateway 313, and media application server 349. The SPAN devices can communicate with each recorder 339, 343 to determine whether the SPAN devices can be configured to adjust the packet size of the communications data. The recorder 339, 343 can request the SPAN devices to generate a certain packet size of the communications data to improve, e.g., optimize, the performance of the recorder. For example, the packet size can be adjusted to be, for example, 20 ms, 180 ms, or 1 second (s) of audio data in a single frame, which is then transmitted over the network using a real-time transport protocol (RTP) using, for example, a G.711 or G.729—both are standards for audio coding. In general, a packet size of approximately greater than 160 millisecond (ms) of communications data facilitates reducing the number of times the recorder processes a packet of communications data.

Alternatively or additionally, the SPAN devices can obtain information associated with the transmission bandwidth of the network via a network server (not shown). The SPAN devices can be configured to adjust the packet size of the communications data to improve, for example, the transmission bandwidth of the network. For example, at a central office of a customer center, the packet size can be increased because the transmission bandwidth of the network at the central office can sustain the increased packet size without diminishing the performance of the network. On the other hand, at a branch office with typically less transmission bandwidth than the central office, the packet size can be decreased to avoid diminishing the performance of the network.

Alternatively or additionally, the SPAN devices can further be configured to change the codec type of the communications data to improve the performance of the recorder. The type of codec includes, but is not limited to, G711 format, G729 format, moving picture experts group audio layer 3 (MP3) and Windows® media audio (WMA), among others. Alternatively or additionally, the SPAN devices can further be configured to mix at least two audio streams of the communications data into one stream and transmit the mixed audio stream to the recorder. This can increase the performance of the recorder by enabling the recorder to focus on recording the mixed audio stream rather than mixing the audio streams.

Alternatively or additionally, if the SPAN devices determine that the audio streams are to be processed for speech recognition based on a business policy, the SPAN devices may not mix the audio streams and transmits the two audio streams to a recorder from which the two audio streams can be retrieved by a speech recognition server. An operation of the SPAN devices is further described in relation to FIG. 4.

### Conferencing

In another scenario, for example, each recorder 339, 343 can communicate with the conference bridge 309 to determine whether the conference bridge 309 can be configured to adjust the packet size and/or change the codec type of the communications data. In this embodiment, calls from the customer phone (not shown) can be routed to a voice gateway 313, which can route the calls to the soft switch 306. The soft switch 306 receives incoming calls and routes the calls to the agent phones 319, 323, 326. The soft switch 306 communicates with the conference bridge 309 via the company network 316.

The soft switch 306 is operative to send a command to the agent phones 319, 323, 326 and voice gateway 306 via the company network 316, instructing the agent phones 319, 323, 326 and voice gateway 306 to transmit the communications data associated with the calls through the conference bridge 309 via the company network 316. The recorders 339, 343 can communicate with the conference bridge via the IP network 333 and the company network 316 to determine a desired, e.g., optimal, packet size and codec type of the communications data based on the capabilities of the recorders 339, 343.

Once the conference bridge 309 determines the desired packet size and codec type of the communications data for the recorders 339, 343, the conference bridge 309 receives the communications data from the agent phones 319, 323, 326 and voice gateway 306, adjusts the packet size and/or changes the codec type according to the determined packet size and codes type, respectively. Alternatively or additionally, the conference bridge 309 can adjust the packet size of the communications data to improve, for example, the transmission bandwidth of the networks 316, 333. Alternatively or additionally, the conference bridge 309 can further be configured to mix at least two audio streams of the communications data into one stream and transmit the mixed audio stream to the recorder.

Alternatively or additionally, the conference bridge 309 can determine whether the agent phones 319, 323, 326 and voice gateway 313 can adjust the packet size, change codec type and/or mix media streams. Responsive to determining that the agent phones 319, 323, 326 and voice gateway 313 have the capabilities, the conference bridge 309 can request the agent phones 319, 323, 326 and voice gateway 313 to adjust the packet size, change codec type and/or mix media streams and transmit the modified communications data to the conference bridge 309. The conference bridge 309 then transmits the modified communications data to the recorders 339, 343 to record the modified communications data in optimal fashion. An operation of the conference bridge 309 is further described in relation to FIG. 5.

### Duplicate Media Streaming

In another scenario, for example, each recorder 339, 343 can communicate with a duplicate media streaming (DMS) device to determine whether the DMS device can be configured to adjust the packet size and/or change the codec type of the communications data. In general, the DMS device can receive, duplicate and transmit the communications data to the recorder 339, 343 without using the conference bridge 309. The DMS device includes, but is not limited to, the soft/IP phone 319, 323, 326, soft switch 306, voice gateway 313, and media application server 349, among others.

A. Soft/IP Phones

In one scenario, for example, each recorder 339, 343 can communicate with the agent phones 319, 323, 326 in a spanning environment to determine whether the phones can be configured to adjust the packet size of the communications data. The recorder 339, 343 can request the agent phones 319, 323, 326 to generate a certain packet size of the communications data to improve the performance of the recorder.

Alternatively or additionally, the phones 319, 323, 326 can obtain information associated with the transmission bandwidth of the network via a network server (not shown). The phones 319, 323, 326 can be configured to adjust the packet size of the communications data to improve the performance of the network.

Alternatively or additionally, the agent phones 319, 323, 326 can further be configured to change the codec type of the communications data to improve the performance of the recorder. Alternatively or additionally, the agent phones 319, 323, 326 can further be configured to mix at least two audio streams of the communications data into one stream and transmit the mixed audio stream to the recorder. An operation of the agent phone is further described in relation to FIG. 4.

B. Soft Switch

In general, calls from a customer phone can be routed to the voice gateway 313, which can route the calls to the soft switch 306. The soft switch 706 receives incoming calls and routes the calls to the agent phones 319, 323, 326. The soft switch 306 can duplicate and transmit the communications data associated with the calls to the recorders 339, 343 using the IP network 333. The recorders 339, 343 can communicate with the soft switch 306 via the IP network 333 and the company network 316 to determine the desired packet size and codec type of the communications data based on the capabilities of the recorders 339, 343. The recorders 339, 343 can use Session Initiation Protocol (SIP) or a computer telephony integration (CTI) link to communicate with the soft switch 306.

Once the soft switch 306 determines the desired packet size and codec type of the communications data for the recorders 339, 343, the soft switch 306 receives the communications data from the voice gateway 306, adjusts the packet size and/or changes the codec type according to the determined packet size and codec type, respectively. Alternatively or additionally, the soft switch 306 can adjust the packet size of the communications data to improve, for example, the transmission bandwidth of the network. Alternatively or additionally, the soft switch 306 can further be configured to mix at least two audio streams of the communications data into one stream and transmit the mixed audio stream to the recorder.

Alternatively or additionally, the soft switch 306 can determine whether the voice gateway 313 can adjust the packet size, change codec type and/or mix media streams. Responsive to determining that the voice gateway 313 has the capabilities, the soft switch 306 can request the voice gateway 313 to adjust the packet size, change codec type and/or mix media streams and transmit the modified communications data to the soft switch 306. The soft switch 306 then transmits the modified communications data to the recorders 339, 343 to improve the performance of the recorders 339, 343 to record the modified communications data. An operation of the soft switch 306 is further described in relation to FIG. 5.

C. Media Application Server

In general, the media application server 349 receives incoming media communications, identifies the type of media communications, and routes the media communications to media communication devices 359, 363 via the company network 316. The media application server 349 can send a command to the media communication devices 359, 363 via the company network 316, instructing the media communication devices 359, 363 to transmit the media communications through the media application server 349 via the company network 316. The media application server 349 duplicates and transmits the media communications to the recorders 333, 343 using the IP network 333. The recorders 339, 343 can communicate with the media application server 349 via the IP network 333 and the company network 316 to determine the desired packet size and codec type of the communications data based on the capabilities of the recorders 339, 343.

Once the media application server 349 determines the desired packet size and codec type of the communications data for the recorders 339, 343, the media application server 349 receives the communications data from the media communication devices 359, 363, adjusts the packet size according to the determined packet size and/or changes the codec type according to the determined codec type. Alternatively or additionally, the media application server 349 can adjust the packet size of the communications data to improve, for example, the transmission bandwidth of the network.

Alternatively or additionally, the media application server 349 can determine whether the media communication devices 359, 363 can adjust the packet size, change codec type and/or mix media streams. Responsive to determining that the media communication devices 359, 363 have the capabilities, the media application server 349 can request the media communication devices 359, 363 to adjust the packet size, change codec type and/or mix media streams. The media communication devices 359, 363 then transmit the modified communications data to the media application server 349. The media application server 349 then transmits the modified communications data to the recorders 339, 343 to improve the performance of the recorders 339, 343 to record the modified communications data. An operation of the media application server 349 is further described in relation to FIG. 5.

D. Voice Gateway

The voice gateway 313 can perform the functions of duplicating and transmitting the communications data to the recorders 339, 343. For example, the voice gateway 313 receives instructions to record communications data from the soft switch 306. The voice gateway 313 receives, manages, and routes the communications data to the agent phones 319, 323, 326 via the company network 316. The voice gateway 313 determines whether to record the received communications data at the agent phones 319, 323, 326 according to the received instructions. If the voice gateway 313 determines that the communications data are to be recorded, the voice gateway 313 duplicates and transmits the communications data to the recorders 339, 343, using the networks 316, 333.

The recorders 339, 343 can communicate with the voice gateway 313 via the IP network 333 and the company network 316 to determine the desired packet size and codec type of the communications data based on the capabilities of the recorders 339, 343. Once the voice gateway 313 determines the desired packet size and codec type of the communications data for the recorders 339, 343, the voice gateway 313 receives the communications data from the agent phones 319, 323, 326, adjusts the packet size according to the determined packet size and/or changes the codec type according to the determined codec type.

Alternatively or additionally, the voice gateway 313 can adjust the packet size of the communications data to improve, for example, the transmission bandwidth of the network. Alternatively or additionally, the voice gateway 313 can determine whether the agent phones 319, 323, 326 can adjust the packet size, change codec type and/or mix media streams. Responsive to determining that the agent phones 319, 323, 326 have the capabilities, the voice gateway 313 can request the agent phones 319, 323, 326 to adjust the packet size, change codec type and/or mix media streams. The agent phones 319, 323, 326 then transmit the modified communications data to the voice gateway 313. The voice gateway 313 then transmits the modified communications data to the recorders 339, 343 to improve the performance of the recorders 339, 343 to record the modified communications data.

Alternatively or additionally, the voice gateway 313 is operative to be configured to duplicate the communications data and transmit the duplicated communications data to a second voice gateway (not shown). The second voice gateway transmits the duplicated communications data to a desired endpoint component, such as the recorders 333, 343, using one of an endpoint component name, an IP address, a SIP address, and a domain name system (DNS) name of the desired endpoint component across the company and/or IP networks 316, 333. The second voice gateway can modify the duplicated communications data similar to the operations of voice gateway 313 explained above. An operation of the voice gateway 313 is further described in relation to FIG. 5.

### Storing and Forwarding

In another scenario, for example, each recorder 339, 343 can communicate with the capture control server 303 to determine whether a computing device having the capabilities of capturing screen and audio of the communications data can be configured to adjust the packet size and/or change the codec type of the communications data.

The media communication device 359, 363 can include, but not limited to, a computing device. The computing device 359, 363 can be coupled to the agent phone 319, 323, 326 via the network 316. Alternatively or additionally, although not shown, computing device 359, 363 can be directly coupled to the agent phone 319, 323, 326 without using the company network 316. The computing device 359, 363 is further configured to send at least a portion of communications data to the recorders 339, 343. The computing device 359, 363 includes a screen capture daemon configured to facilitate capture of visual data related to the communications data, a capture control daemon configured to assemble communications data into data streams, and a voice capture daemon configured to facilitate capture of audio data. A capture control server 303 communicates with the computing device 359, 363 and is configured to provide a command to the computing device. The recorders 339, 343 can communicate with the capture control server 303 via the IP network 333 and the company network 316 to determine the desired packet size and codec type of the communications data based on the capabilities of the recorders 339, 343.

Once the capture control server 303 determines the desired packet size and codec type of the communications data for the recorders 339, 343, the capture control server 303 communicates with computing device 359, 363 to determine whether the computing device 359, 363 can adjust the packet size, change codec type and/or mix media streams. If the computing device 359, 363 has the capabilities, the capture control server 303 transmits a command associated with the determined packet size and codec type of the communications data. Responsive to receiving the command, the computing device 359, 363 receives the captured communications data from the agent phones 319, 323, 326, voice gateway 306 and media application server 349, adjusts the packet size according to the determined packet size and/or changes the codec type according to the determined codec type.

Alternatively or additionally, the computing device 359, 363 can adjust the packet size of the communications data to improve the capabilities of the network, e.g., transmission bandwidth. Alternatively or additionally, the computing device 359, 363 can determine whether the agent phones 319, 323, 326, voice gateway 313, and media application server 349 can adjust the packet size, change codec type and/or mix media streams.

Responsive to determining that the agent phones 319, 323, 326, voice gateway 313, and media application server 349 have the capabilities, the computing device 359, 363 can request the agent phones 319, 323, 326, voice gateway 313, and media application server 349 to adjust the packet size, change codec type and/or mix media streams and transmit the modified communications data to the computing device 359, 363. The computing device 359, 363 then captures the modified communications data and transmits the captured communications data to the recorders 339, 343 to improve the performance of the recorders 339, 343 to record the modified communications data. Alternatively or additionally, the computing device 359, 363 can forward the stored communications data from one recording system to another recording system. An operation of the computing device 359, 363 is further described in relation to FIG. 5.

FIG. 4 is a flowchart illustrating exemplary steps that can be taken by a telephony component for recording a contact in a communications network, such as that described in FIG. 3. Beginning with Step 410, the telephony component communicates with a recorder to determine the capabilities of the recorder. Step 415 obtains information associated with the transmission bandwidth of the communications network. In general, the telephony component can obtain information associated with the customer center's communications infrastructure. For example, the telephony component obtains not only information associated with the transmission bandwidth, but also, bandwidth allocation, network usage and network traffic, among others.

Step 420 determines whether the telephony component can be configured to adjust the packet size of data associated with communications at a customer center, change the codec type of the communications data, and mix at least two media streams associated with the communications data into one stream. If the packet size is determined to be adjusted, step 425 adjusts the packet size of the communications data based on the capabilities of the communications infrastructure and/or recorder. If the codec type is determined to be changed, step 430 changes the codec type of the communications data based on the capabilities of the recorder.

If the media streams associated with the incoming call is determined to be mixed into one stream, step 435 mixes the media streams into one stream based on business policy. For example, if the audio streams are not processed for speech recognition, then the audio streams are mixed and transmitted to the recorder to be recorded. If the audio streams are to be processed for speech recognition, then the two audio streams are not mixed and transmitted as two separated audio streams to a speech recognition server. Step 440 transmits the communications data with the adjusted packet size, changed codec type, and/or mixed media streams to the recorder to be recorded.

FIG. 5 is a flowchart illustrating exemplary steps that can be taken during conferencing, duplicate media streaming, and storing-forwarding for recording a contact in a communications network, such as that described in FIG. 3. Step 510 communicates with a recorder to determine the capabilities of the recorder. Step 515 obtains information associated with the transmission bandwidth of the communications network.

Step 520 determines whether telephony components, conference bridge, DMS device and store-forward devices can be configured to adjust the packet size of data associated with the communications at a customer center, change the codec type of the communications data, and/or mix at least two media streams associated with the communications data into one stream. The telephony components that transmit communications data to the conference bridge include, but are not limited to, agent phones 319, 323, 326 and voice gateway 313. The telephony components that transmit communications data to the DMS device include, but are not limited to, agent phones 319, 323, 326, media communication device 359, 363, voice gateway 313 and customer phones, among others. The telephony components that transmit communication data to the store-forward device include, but are not limited to, agent phones 319, 323, 326, voice gateway 306 and media application server 349. In general, the telephony components transmit communications data to the conference bridge, DMS device, and store-forward device, which, in turn, transmit the communications data to the recorders 339, 343.

If the telephony components are determined to have the capabilities, step 521 requests the telephony components to modify the communications data based on the capabilities of the network and/or recorder. If the telephony components do not have the capabilities, then the conference bridge, DMS device, and/or store-forward device, as in step 523, receive the communications data and modify the communications data based on the capabilities of the network and/or recorder. The conference bridge, DMS device, and/or store-forward device can modify the recorder's streams and/or all streams associated with the communications data.

Alternatively or additionally, the conference bridge, DMS device, and/or store-forward device can receive modified communications data from one source and non-modified communications data from another source. In this case, the conference bridge, DMS device, and store-forward device directly transmit the modified communications data to the recorder. However, the conference bridge and/or DMS device can modify the non-modified communications data and then transmit the modified communications data to the recorder.

Either with the telephone components, conference bridge, DMS device, and/or store-forward device, if the packet size is determined to be adjusted, step 525 adjusts the packet size of the communications data based on the capabilities of the network and/or recorder. If the codes type is determined to be changed, step 530 changes the codec type of the communications data based on the capabilities of the recorder. If the media streams associated with the incoming call is determined to be mixed into one stream, step 535 mixes the media streams into one stream based on business policy. Step 540 transmits the communications data with the adjusted packet size, changed codec type, and/or mixed media streams to the recorder to be recorded.

FIG. 6 is a flowchart illustrating exemplary steps that can be taken for a recorder in a communications network, such as that described in FIG. 3. Step 610 communicates with a telephony component to determine the capabilities of the telephony component through, for example, SIP using Session Description Protocol (SDP). Step 615 obtains information associated with the transmission bandwidth of the communications network.

Step 620 determines whether the telephony component can be configured to adjust the packet size of data associated with the communications at a customer center, change the codec type of the communications data, and/or mix at least two media streams associated with the communications data into one stream. If the telephony component is determined to have the capabilities, step 621 requests the telephony component to modify the communications data based on the capabilities of the network and/or recorder. Step 630 receives the communications data with the adjusted packet size, changed coder type, and/or mixed media streams to the recorder to be recorded. If the telephony components do not have the capabilities, then step 623 receives the communications data that have not been modified by the telephony component.

It should be noted that the telephony component can include a static and/or dynamic configuration. For example, the dynamic configuration can be based on adaptive learning. That is, the telephony component with adaptive learning can modify the communications data based on the characteristics of the recorder, characteristics of the network business rules, and/or geographical locations. For example, the telephony component can modify the communications data at a certain time, such as, for example, at 2:00 pm of the weekdays, on certain days of the week, on a certain week of the month, on a holiday of the year, and at a certain season of the year, among others. In yet another example, the telephony component can modify the communications data associated with a certain type of calls, such as, billing service, technical service, new customer service, among others. In yet another example, the telephony component can modify the communications data based on the current network performance. That is, the telephony component can modify the communications data at a first time period when the network performance is optimal; but the telephony component does not modify the communications data at a second time period when the network performance is unsatisfactory.

Alternatively or additionally, the recorder can have a dynamic configuration associated with modifying the communications data. That is, the recorder can instruct a telephony component to modify the communications data according to the different scenarios explained above, such as, predetermined time, predetermined bandwidth and predetermined packet size, among others. For example, the recorder determines that the network performance is optimal at a first time period and instructs the telephony component to modify the communications data during the first time period. However, the recorder determines that the network performance is unsatisfactory at a second time period and instructs the telephony component not to modify the communications data at the second time period.

The static configuration associated with modifying the communications data can be manually set for the telephony components. For example, the telephony components related to, such as, but not limited to, conference bridge, DMS device, and/or store-forward device, can be set to increase the packet size to 160 ms and change the codec type to G711 for all communications data before the communications data are transmitted to the recorder. Alternatively or additionally, the static configuration can involve streams associated with the conference bridge, DMS device, and/or store-forward device, apart from the streams associated with the headset.

Alternatively or additionally, although the recording system can communicate with the conference bridge via the soft switch as mentioned above, the recording system can communicate with other telephony component via the soft switch. Alternatively or additionally, the recording system can communicate with any telephony component via a proxy server.

One should also note that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

One should note that any of the programs listed herein, which can include an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software-configured mediums.

This application is related to copending U.S. utility application entitled, “Systems and Methods for Endpoint Recording Using Recorders,” having Ser. No. 11/540,902, filed on Sep. 29, 2006, which is hereby incorporated by reference in its entirety, copending U.S. utility application entitled, “Duplicate Media Stream,” having Ser. No. 11/394,496, filed on Mar. 31, 2006, which is hereby incorporated by reference in its entirety, copending U.S. utility application entitled, “Distributed Voice Over Internet Protocol Recording,” having Ser. No. 11/394,408, filed on Mar. 31, 2006, which is hereby incorporated by reference in its entirety, copending U.S. utility application entitled, “Systems and Methods For Endpoint Recording Using Phones,” having Ser. No. 11/394,410, filed Mar. 31, 2006, which is entirely incorporated herein by reference, copending U.S. utility application entitled, “Systems and Methods For Endpoint Recording Using a Conference Bridge,” having Ser. No. 11/395,350, filed Mar. 31, 2006, which is entirely incorporated herein by reference, and copending U.S. utility application entitled, “Systems and Methods For Endpoint Recording Using a Media Application Server,” having Ser. No. 11/395,759, filed Mar. 31, 2006, which is entirely incorporated herein by reference.

It should be emphasized that the above-described embodiments are merely possible examples of implementations, merely set forth for a clear understanding of the principles of this disclosure. Many variations and modifications may be made to the above-described embodiment(s) without departing substantially from the spirit and principles of the disclosure. All such modifications and variations are intended to be included herein within the scope of this disclosure.

Therefore, at least the following is claimed:

1. A method for recording in a customer center environment, comprising:
receiving data related to a communication;
communicating with a recording system to determine the capabilities of the recording system;
determining whether to adjust a packet size of the data based on the processing capabilities of the recording system;
responsive to determining that the packet size is to be adjusted, adjusting the packet size of the data based on the processing capabilities of the recording system; and
transmitting the data with the adjusted packet size to the recording system.

2. The method of claim 1, further comprising obtaining information associated a customer center communications infrastructure, the information relating to transmission bandwidth of a communications network associated with the recording system.

3. The method of claim 2, wherein adjusting the packet size of the data is further based on the transmission capabilities of the communications network, the transmission capabilities relating to at least one of network usage and network traffic.

4. The method of claim 2, further comprising:
determining whether to perform at least one of the following: changing a codec type of the data and mixing media streams of the data into a single stream based on the transmission capabilities of the communications network;
responsive to determining that the codec type is to be changed, changing the codec type of the data based on the transmission capabilities of the communications network; and
responsive to determining that the media streams are to be mixed, mixing the media streams into the single stream based on the transmission capabilities of the communications network.

5. The method of claim 1, further comprising:
determining whether to perform at least one of the following: changing the codec type of the data based on whether the recording system is operative to process the changed codec type and mix media streams of the data into a single stream based on a business policy;
changing the codec type of the data; and
responsive to determining that the media streams are to be mixed, mixing the media streams into the single stream based on the business policy.

6. The method of claim 1, wherein communicating with a recording system to determine the processing capabilities of the recording system includes communicating with at least one of the following: a conference bridge, a duplicate media device, and a store-forward device.

7. The method of claim 6, further comprising determining whether telephony components are operable to perform at least one of the following: adjust the packet size of the communications data, change the codec type of the communications data, and mix at least two media streams associated with the communications data into one stream, the telephony components that transmit communications data to the conference bridge including agent phones and voice gateway, the telephony components that transmit communications data to the DMS device including agent phones, media communication device, voice gateway and customer phones, the telephony components that transmit communication data to the store-forward device including agent phones, voice gateway and media application server.

8. The method of claim 7, further comprising requesting the telephony components to either adjust the packet size of the communications data, change the codec type of the communications data, or mix at least two media streams associated with the communications data into one stream.

9. The method of claim 7, further comprising responsive to determining that the telephony components do not have the capabilities, receiving the communications data from the telephony components and using at least one of the conference bridge, duplicate media device, and store-forward device to perform at least one of the following: adjust the packet size of the communications data, change the codec type of the communications data, and mix at least two media streams associated with the communications data into one stream.

10. The method of claim 1, further comprising:
configuring manually the telephony components related to conferencing, duplicate media streaming, and/or storing-forwarding to increase or decrease the packet size and change the codec type of the communications data before the communications data.

11. A system for recording communications at customer center environment, comprising:
a recording system coupled to a network records communications data; and
a telephony component operable to communicate with the recording system to determine processing capabilities of the recording system, the telephony component being further operable to determine whether to adjust packet size of the data based on the processing capabilities of the recording system, responsive to determining that the packet size is to be adjusted, the telephony component being further operable to receive the communications data and adjust the packet size of the data based on the processing capabilities of the recording system, the telephony component being further operable to transmit the communications data with the adjusted packet size to the recording system.

12. The system of claim 11, wherein the telephony component includes a device with SPAN features, a soft phone and an IP phone, the telephony component being operable to obtain information associated with the transmission bandwidth of a communications network associated with the recording system.

13. The system of claim 12, wherein the telephony component is further operable to adjust the packet size of the data based on the transmission capabilities of the communications network.

14. The system of claim 12, wherein the telephony component is further operable to determine whether to perform at least one of the following: changing the codec type of the data and mixing media streams of the data into a single stream based on the transmission capabilities of the communications network;
responsive to determining that the codec type is to be changed, changing the codec type of the data based on the transmission capabilities of the communications network; and
responsive to determining that the media streams are to be mixed, mixing the media streams into the single stream based on the transmission capabilities of the communications network.

15. The system of claim 11, wherein the telephony component is further operable to:
determine whether to perform at least one of the following: changing the codec type of the data based on whether the recording system is operative to process the codec type and mix media streams of the data into a single stream based on a business policy;
changing the codec type of the data; and
responsive to determining that the media streams are to be mixed, mixing the media streams into the single stream based on the business policy.

16. A media processing and distributing device for facilitating a recording in a customer center environment, comprising:
logic for receiving data related to a communication;
logic for communicating with a recording system to determine the processing capabilities of the recording system;
logic for determining whether to adjust packet size of the data based on the processing capabilities of the recording system;
logic for responsive to determining that the packet size is to be adjusted, adjusting the packet size of the data based on the processing capabilities of the recording system; and
logic for transmitting the data with the adjusted packet size to the recording system.

17. The media processing and distributing device of claim 16, further comprising logic for obtaining information associated with the transmission bandwidth of a communications network associated with the recording system.

18. The media processing and distributing device of claim 17, wherein the logic for adjusting the packet size of the data is further based on the transmission capabilities of the communications network.

19. The media processing and distributing device of claim 16, further comprising logic for:
determining whether to change the codec type of the data based on whether the recording system is operative to process the codec type; and
changing the codec type of the data.

20. The media processing and distributing device of claim 16, further comprising logic for:
determining whether to mix media streams of the data into a single stream based on a business policy; and
responsive to determining that the media streams are to be mixed, mixing the media streams into the single stream based on the business policy.

21. The media processing and distributing device of claim 16, wherein the media processing and distributing device includes a conference bridge, duplicate media device, and store-forward device.

22. The media processing and distributing device of claim 21, wherein at least one of the conference bridge, duplicate media device, and store-forward device is operable to determine whether telephony components are operable to perform at least one of the following: adjust the packet size of the communications data, change the codec type of the communications data, and mix at least two media streams associated with the communications data into one stream, the telephony components that transmit communications data to the conference bridge including agent phones and voice gateway, the telephony components that transmit communications data to the DMS device including agent phones, media communication device, voice gateway and customer phones, the telephony components that transmit communication data to the store-forward device including agent phones, voice gateway and media application server.

23. The media processing and distributing device of claim 22, wherein at least one of the conference bridge, duplicate media device, and store-forward device is operable to either request the telephony components to either adjust the packet size of the communications data, change the codec type of the communications data, or mix at least two media streams associated with the communications data into one stream.

24. The media processing and distributing device of claim 22, wherein responsive to determining that the telephony components do not have the capabilities, at least one of the conference bridge, duplicate media device, and store-forward device is further operable to receive the communications data from the telephony components and modify the communications data by way of the one of the following: adjust the packet size of the communications data, change the codec type of the communications data, and mix at least two media streams associated with the communications data into one stream.

25. A method for recording a communication at a customer center environment comprising:
communicating with a telephony component in a communications network associated with a recording system to determine the telephony components capabilities;
determining whether the telephony component can modify the communications data associated with the communication based on the capabilities of the telephony component;
responsive to determining that the telephony component has the capabilities, transmitting instructions to the telephony component to modify the communications data based on the capabilities of the telephony components;
receiving the modified communications data from the telephony component; and
recording the received communications data.

26. The method of claim 25, further comprising instructing the telephony component to perform one of the following: adjust packet size of the data based on the capabilities of the telephony component, change the codec type of the data, and mix at least two streams of the data into a single stream.

27. The method of claim 25, further comprising obtaining information associated with the transmission bandwidth of a communications network associated with the recording system.

28. The method of claim 27, further comprising instructing to the telephony component to adjust the packet size of the data based on the transmission capabilities of the communications network.

29. The method of claim 25, wherein communicating with the telephony component is achieved by way of one of a soft switch and a proxy server.

30. A method for recording in a customer center environment, comprising:
receiving data related to a communication;
communicating with a recording system to determine the capabilities of the recording system;
determining whether to adjust a packet size of the data based on a customer center communications infrastructure;
responsive to determining that the packet size is to be adjusted, adjusting the packet size of the data based on the customer center communications infrastructure; and
transmitting the data with the adjusted packet size to the recording system.

31. The method of claim 30, further comprising obtaining information associated the customer center communications infrastructure, the information relating to at least one of transmission bandwidth, bandwidth allocation, network usage and network traffic.

32. The method of claim 30, further comprising adjusting the packet size of the data based on at least one of predetermined time, predetermined bandwidth, and predetermined packet size.
